(19) United States
(12) Patent Application Publication
(10) Pub. No.: US 2012/0084643 A1
(43) Pub. Date: Apr. 5, 2012

(54) COMPONENT-SPECIFIC AND SOURCE-AGNOSTIC LOCALIZATION

(76) Inventors: BALAJI GOVINDAN, Chennai (IN); Anand M.S, Chennal (IN); Dhruva Sagar, Mumbai (IN)

(21) Appl. No.: 12/894,148

(22) Filed: Sep. 30, 2010

(51) Int. Cl. G06F 17/21

(52) U.S. Cl. 715/255

(57) ABSTRACT

Various embodiments of systems and methods for component-specific and source agnostic localization are described herein. An adapter interface is provided for one or more adapters such that the one or more adapters implement the adapter interface with a plurality of sources having a plurality of data formats. The plurality of sources includes localization adaptation content. One or more localization bundles are created for one or more consuming components. Each localization bundle is associated with at least one adapter of the one or more adapters. The one or more localization bundles are registered with a localization service. The localization service is consumed for obtaining portions of the localization adaptation content required for the one or more consuming components.

### FIELD

The field relates generally to localization of products or services to adapt to distinct target markets or groups. More particularly, the field is related to a component-specific and source-agnostic localization method and system for a framework supporting multiple applications.

### BACKGROUND

Many software and computer-implemented applications are typically required to have to the flexibility to support various languages, customs, and other preferences of user groups belonging to various countries, regions, cultures, and geographic locations. Localization is a process of adapting an application to a specific language or locale. Depending on the type of the application, a localization process includes various adaptations such as, for example, translating text, messages, and menus, adapting input fields such as date and time fields, providing appropriate symbols such as currency symbols, and adapting user interface layout.

Localization can be provided as a service for use by multiple applications to fetch and apply the adaptations during application runtime. But in a framework that supports multiple applications, each application creates its own set of client user interface (UI) components that localize and bundle adaptations along with the UI component because the framework or applications may or may not support all data formats. Adaptations required by a UI component can be present in various sources such as, for example, Extensible Markup Language Localization Interchange File Format (XLIFF) files, Advanced Business Application Programming (ABAP, developed by SAP AG of Walldorf, Germany) programs, and legacy databases.

However, creating and bundling adaptations along with each UI component can consume significant time and resources. Specifically, this will lead to re-building or recreating of existing adaptations that may already be present in various sources in different formats. Also, the cost of making adaptations for each component can be significant. It would therefore be desirable to provide a component-specific and source agnostic localization model that can be implemented by components that require adaptations.

### SUMMARY

Various embodiments of systems and methods for component-specific and source-agnostic localization are described herein. An adapter interface is provided for one or more adapters such that the one or more adapters implement the adapter interface with a plurality of data sources having a plurality of data formats. The data sources include localization adaptation content. One or more localization bundles are created for one or more consuming components. Each localization bundle is associated with at least one adapter of the one or more adapters. The one or more localization bundles are registered with a localization service. The localization service is consumed for obtaining portions of the localization adaptation content required for the one or more consuming components.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a method of providing localization data, according to one embodiment.

FIG. 2 is an architecture-level block diagram for providing localization adaptation data, according to one embodiment.

FIG. 3 is a block diagram illustrating a framework's part of implementing the method of providing localization adaptation data, according to one embodiment.

FIG. 4 is a block diagram illustrating an application developer's part of implementing the method of providing localization adaptation data, according to one embodiment.

FIG. 5 is a runtime flow diagram of an application consuming localization adaptation data, according to one embodiment.

FIG. 6 illustrates an exemplary interface of an application of a framework, according to one embodiment.

FIG. 7 illustrates an exemplary interface of an application with generated user interface components, according to one embodiment.

FIG. 8 is a block diagram of an exemplary computer system according to one embodiment.

### DETAILED DESCRIPTION

Embodiments of techniques for component-specific and source-agnostic localization are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

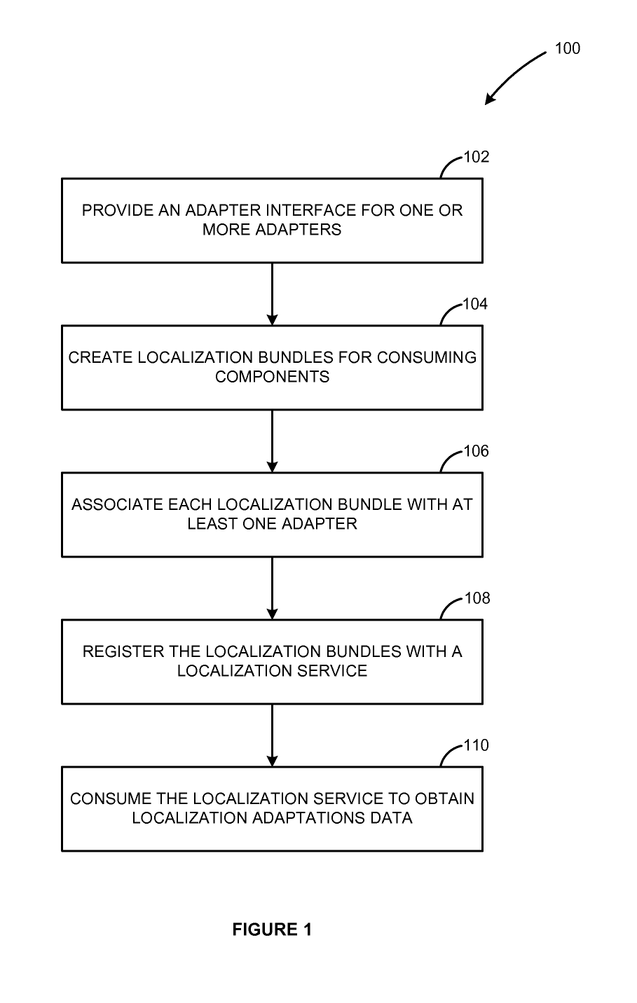

FIG. 1 illustrates a method 100 of providing localization adaptation data according to one embodiment. The method can be used with a framework that supports multiple applications. Each such application can have several consuming components that are designed and developed by an application developer. In one embodiment, the framework can be an SAP framework such as Performance Optimization Applications, Shared Business Components, Enterprise Performance Management applications, and Business User Interface (products of SAP AG of Walldorf, Germany). Such framework can support multiple applications that include SAP's applications, customer applications, and other associated applications.

Data from the data sources can be used for several purposes. For example, the consuming components of an application may need to retrieve the data or content in the data sources to generate user interface components. But data sources can have content in different data formats. Some of the exemplary data formats include XLIFF format, ABAP format, text format, tabular format, spreadsheet format (e.g. MICROSOFT® EXCEL), and other legacy database formats. The localization adaptation content can include, for example, translations of text. These translations can also be in any of the data formats and may need to be retrieved by the consuming components.

At 102, an adapter interface is provided. In one embodiment, a framework can provide the adapter interface. An exemplary adapter interface is provided below:

```
interface AdapterInterface
{
    function loadBundle( )
    function getMap( )
    function getDefaultMap( )
}
```

The adapter interface is provided for one or more adapters. The adapters implement the adapter interfaces with the data sources. An adapter is provided for one data source to retrieve the translated texts for consuming components. For example, an XLIFF adapter is provided for an XLIFF data source, an ABAP adapter is provided for an ABAP source, a spreadsheet adapter is provided for a data source having data in a spreadsheet format. If a particular data source includes data in a plurality of data formats, then an adapter is provided for each data format of that data source. The adapters can be provided by the framework. If the adapters for a particular type data format are not provided by the framework, an application developer can create the adapters. Below is an exemplary approach about how an adapter interface can be implemented by an XLIFF adapter.

```
class XLIFFAdapter implements AdapterInterface
{
    function configureAdapter(configInfo) //about file locations
    function loadBundle( ) //implemented for loading XLIFF files
    function getMap( ) //implemented for reading from XLIFF maps
    function getDefaultMap( )
}
```

At 104, localization bundles are created for each consuming component. A unique identifier is assigned to each localization bundle. For example, a localization bundle for a consuming component ‘1’ can be represented as “component1Bundle.” In one embodiment, the unique identifier for the localization bundle includes a combination of a consuming component identifier and an additional identifier.

At 106, each localization bundle is associated with at least one adapter. In another embodiment, a plurality of localization bundles can be associated with an adapter. An exemplary approach of creating a localization bundle for a consuming component ‘1’ and associating the localization bundle for the consuming component ‘1’ with an XLIFF adapter is shown below:

XLIFFAdapter xliffAdapter= new XLIFFAdapter(configurations);
// creating a localization bundle
LocalizationBundle component1Bundle = new LocalizationBundle( );
// associating the localization bundle with an XLIFF adapter
component1Bundle.setAdapter(XLIFFAdapter);

At 108, the localization bundles are registered with a localization service. In one embodiment, the localization service is a singleton service. The localization service is an entry point through which the consuming component fetches the translated texts in the data source through the adapters via the common adapter interface. An exemplary approach of registering the localization bundle with the localization service is shown below:
LocalizationService.registerLocalizationBundle(“Component 1”, component1Bundle);

At 110, the localization service is consumed by the consuming components to obtain translated texts from the data sources. A consuming component may not require all the translated texts in a data source. Depending on the type of the consuming component, only a certain portion of the translated texts may be needed by the consuming component. Therefore, an application developer who develops a consuming component determines and identifies the required portions for that consuming component. The required portions of translated texts are obtained while consuming the localization service. An exemplary approach for retrieving the required portion (which can also be referred to as a key) is shown below:

// Getting the Label
String label = component1Bundle.getLabel(“required portion”);
// Creating an in-memory map and adding it to the LocalizationBundle
Object at runtime
Array map = new Array( );
map[“REQUIRED PORTION 1”] = “value1”;
map[“REQUIRED PORTION 2”] = “value2”;
componentBundle.addToMap(map);

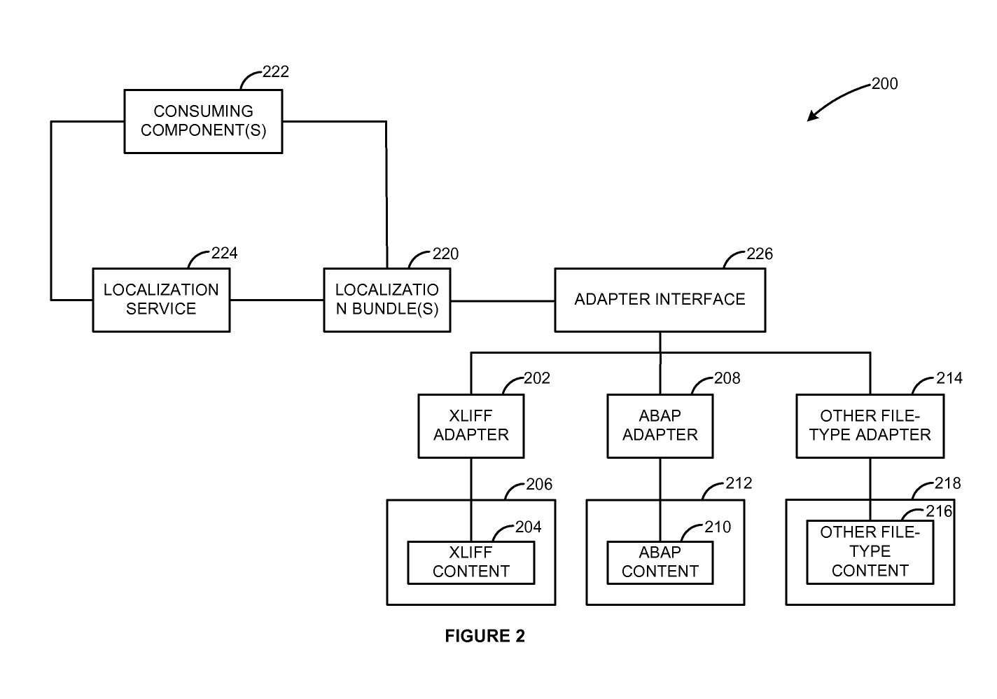

FIG. 2 shows an architecture-level block diagram 200 of an embodiment for providing localization data. Localization adaptation data or content (e.g. translated texts) required for a consuming component can be present in several data sources in different formats. A single data source can also contain content in a plurality of data formats. An adapter is provided for each data format of each data source. For example, an XLIFF adapter 202 is provided for XLIFF content 204 in a data source 206, an ABAP adapter 208 is provided for ABAP content 210 in a data source 212 and, similarly, adapters 214 can be provided for content 216 in other file-types in a data source 218.

At least one localization bundle 220 is created for each consuming component 222. Depending on the type and extent of the content required, a plurality of localization bundles 220 can be created for each consuming component 222. The localization bundles 220 are registered with a localization service 224, which is a singleton class. Each localization bundle 220, which is created for a consuming component 222, is associated with at least one adapter (e.g. 202, 208, 214). For example, for a consuming component ‘1,’ a localization bundle ‘component1 bundle’ is created. An application developer who is developing the consuming component ‘1’ identifies required localization adaptation data or content needed for the consuming component ‘1.’ The data source and the data format of the content are also identified by the application developer. For example, the localization adaptation content such as translated texts required for the consuming component ‘1’ can be part of XLIFF content 204 in a data source 206. Therefore, the ‘component1 bundle’ is associated with the XLIFF adapter 202. In one embodiment, a plurality of localization bundles can be associated with an adapter. For example, translated texts required for both the consuming component ‘1’ and a consuming component ‘2’ can be present in XLIFF content 204. In this case, the ‘component1 bundle’ and a ‘component2 bundle’ can be associated with the XLIFF adapter 202.

An adapter interface 226 is provided for the adapters 202, 208, 214. The localization bundles 220 are created for each consuming component 222 such that the localization bundles 220 expect the adapter interface 226 without the need for knowing the type of the adapter (e.g. step 104 of FIG. 1). Since each localization bundle 220 is associated with at least one adapter (202, 208, and/or 214), the associated adapter implements the adapter interface 226. For example, since the ‘component1 bundle’ is associated with the XLIFF adapter 204, the XLIFF adapter 204 implements the adapter interface 226. The XLIFF adapter 204, ABAP adapter 208, and adapters 210 for other data formats implement the common adapter interface 226. Examples of other data formats include text format, tabular format, spreadsheet format, and other legacy database formats.

To fetch the translated texts, the localization service 224 should be consumed by the consuming components 222. An identifier for a consuming component 222 can be used to get the localization bundle 220 created for that particular consuming component 222. For example, consuming component identifier ‘component1’ can be used by the localization service to get the localization bundle ‘component1 bundle.’ Following which, required portions of the translated texts are fetched into the localization bundle 220 through the adapter interface 226 that is implemented by the adapter associated with the localization bundle 220. For example, the translated texts are fetched into the ‘component1 bundle’ through the adapter interface 226 that is implemented by the XLIFF adapter 204. Portions of translated texts that are required by a consuming component 222 are obtained while consuming the localization service 224 as described previously in reference to step 110 of FIG. 1.

The localization adaptation content, such as translated texts, is not bundled along with the consuming components 222. The translated texts present in the data sources 206, 212, and 218 in different data formats can be fetched through the common adapter interface 226 that is implemented by the adapters 202, 208, and 214. Therefore, there is no need to re-build or recreate existing translated texts or other localization adaptation content that is present in the data sources 206, 212, and 218. The method is specific to a consuming component in that it fetches the translated texts required for that consuming component. The method is also source-agnostic in that it is adaptable to any data source 206, 212, and 218 having localization adaptation content in any data format. Translated texts from any of the data sources having content in any data format can be fetched.

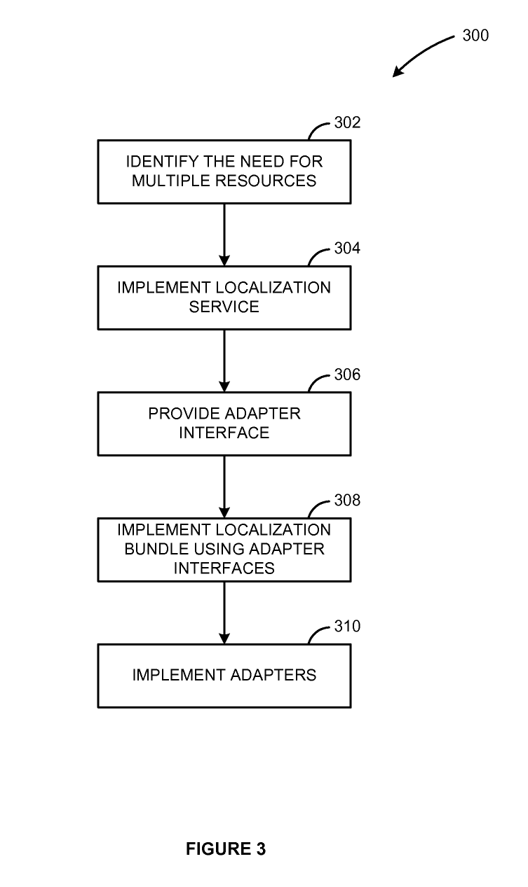

FIG. 3 illustrates a framework's part 300 of implementing the method of providing localization content according to an embodiment in which the framework supports multiple applications. At 302, the need for multiple data resources is identified. Specifically, the need for translations from one or more data sources having content in one or more formats is identified. The localization service is implemented at 304. A common adapter interface is provided at 306. At 308, localization bundles are implemented using the adapter interface. An exemplary approach of implementing a localization bundle is shown below:

```
    class LocalizationBundle
    {
        function setAdapter(Adapter Interface) //expecting an Adapter
Interface without the need for knowing the type of Adapter
        function getLabel(REQUIRED PORTION OF
        TRANSLATED TEXT)
        function addToMap( )
    }
```

The framework also implements adapters at 310. The adapters can be provided by the framework or created by application developers depending on the type of data format. A framework developer can play a role in the above steps.

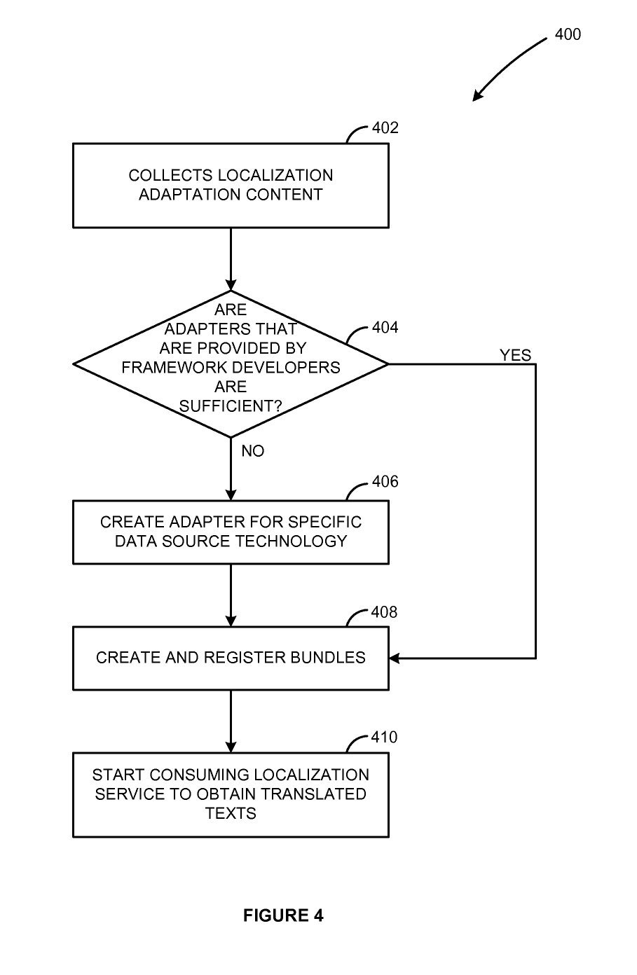

FIG. 4 illustrates an application developer's part 400 of implementing the method of providing localization content according to the embodiment in which the framework supports multiple applications. The application developer develops applications that are supported by the framework. At 402, the application developer collects the content needed for an application. Depending on the type of the application, the content includes localization adaptation content such as translated texts that can be in a plurality of formats and in a plurality of data sources. At, 404, the application developer determines whether the adapters provided by the framework are sufficient. If the adapters are sufficient, then the process moves to step 408. If the adapters are not sufficient, the application developer creates adapters for the data formats of the translated texts at 406. For example, if the framework only provides XLIFF adapter and the translated texts are in a plain text format then the application developer creates a plain text adapter. The process then moves to step 408.

At 408, the application developer creates and registers localization bundles. Specifically, localization bundles are created for consuming components of the application and associated with the respective adapter at 408. The localization bundles are also registered at 408 with the localization service that will be implemented by the framework. At 410, localization service can be consumed to obtain translated texts.

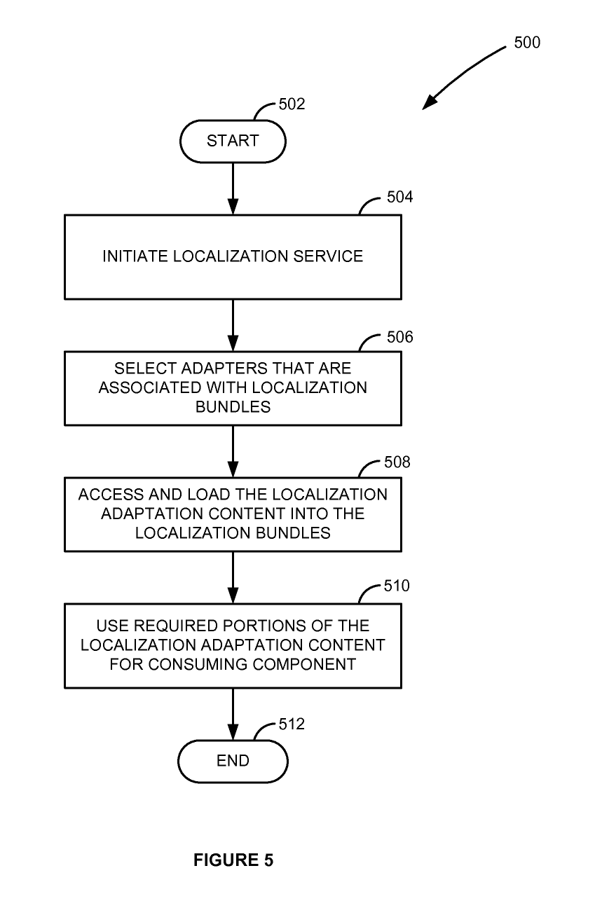

FIG. 5 illustrates a runtime flow diagram 500 of an application that consumes localization adaptation content. The application is started at 502. The application includes consuming components that require translated texts that can be present in different formats in a plurality of sources. As described previously in reference to FIGS. 1 and 2, localization bundles are created for the consuming components and are registered with the localization service. At least one localization bundle is created for each consuming component and each localization bundle is associated with at least one adapter. A localization service is initialized at 504. At 506, adapters associated with the localization bundle are selected. For example, for a consuming component ‘1’ with required translation texts in XLIFF format in a data source, an XLIFF adapter is selected.

At 508, required portions of the translated texts are accessed and loaded into the localization bundles through the adapters and the adapter interface. A particular consuming component may only need a certain portion of the translated texts. Required portions of the translated text are loaded as described in reference to step 110 of FIG. 1. In the previous example of consuming component ‘1,’ translated texts are loaded into the ‘component1 bundle’ from XLIFF content in a data source through the XLIFF adapter that implements the common adapter interface. At 510, the required portions of the translated texts that are loaded into the localization bundles are then used for the one or more consuming components of the application. In one embodiment, user interface components can be generated by using the required portions of the translated texts. The application may end at 512 after using localization adaptation content. In one embodiment, application ends at 512 by displaying user interface components after using localization adaptation content along with any other content.

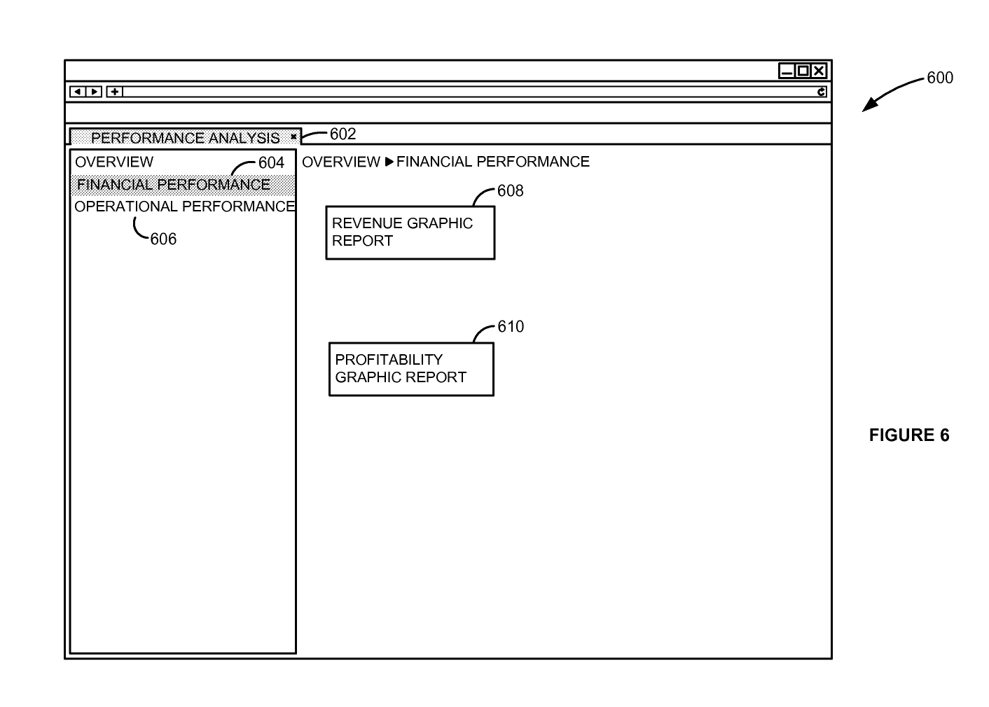

FIG. 6 illustrates an exemplary user interface 600 of an application supported by a framework. The application is a performance analysis application 602, which can have various sections such as a financial performance 604 and an operational performance 606. In the financial performance application 604, there can be sub-applications (can also be referred to as widgets) such as revenue graphic report application 608 and profitability graphic report application 610. Assuming these applications need localization adaptation content, the revenue graphic report application 608 and the profitability graphic report application 610 can be developed by employing the method of providing localization adaptation content as described in reference FIGS. 1 and 2. The revenue graphic report application 608 and profitability graphic report applications 610 can be run by an end user. Localization adaptations content is fetched along with any other required content and user interface components for the revenue graphic report application 608 and profitability graphic report application 610 can then be generated and displayed.

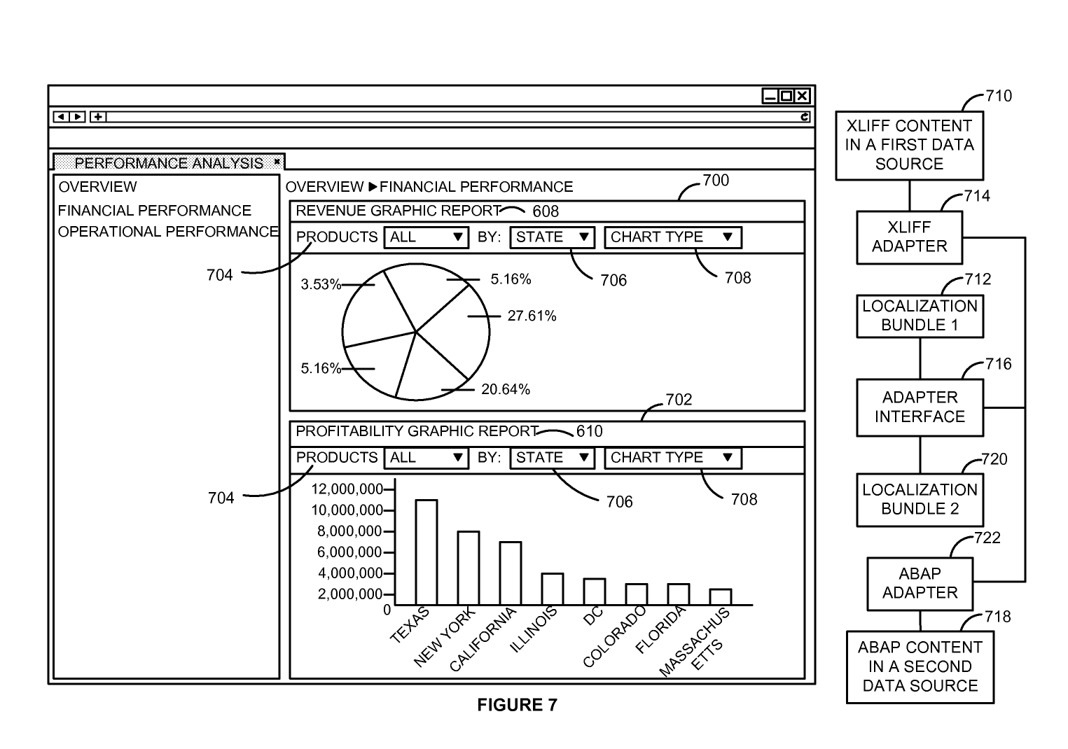

FIG. 7 shows the user interface components 700 and 702 that are generated for the revenue graphic report application 608 and profitability graphic report application 610. The revenue graphic report application 608 and the profitability graphic report application 610 can have consuming components such as, for example, ‘product’ component 704, ‘state’ or ‘territory’ component 706, and ‘chart-type’ component 708. These components may have localization adaptation content (e.g. translated texts or content) in different sources and in different data formats. For example, the ‘chart-type’ component 708 may have XLIFF localization adaptation content 710 in a first data source. Therefore, while developing the graphic report and the profitability graphic report applications, a localization bundle ‘1’ 712 can be created for the ‘chart-type’ component 708 and the localization bundle ‘1’ 712 can be associated with an XLIFF adapter 714 that implements a common adapter interface 716. Required portions of the XLIFF content 710 can then be fetched into the bundle 712 and used by the ‘chart-type’ component 708.

The ‘state’ component 706 may have ABAP localization adaptation content 718 in a second data source. While developing the graphic report and the profitability graphic report applications, a localization bundle ‘2’ 720 can be created for the ‘state’ component 706 and the localization bundle ‘2’ 720 can be associated with an ABAP adapter 722 that implements the adapter interface 716. Required portions of the ABAP content 718 can then be fetched into the localization bundle ‘2’ 720 and used by the ‘state’ component 706. The fetched translated content for the ‘chart-type’ component 710 and ‘state’ component 708 can then be used by the graphic report application 608 and the profitability graphic report application 610 to generate their respective user interface components 700 and 702.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

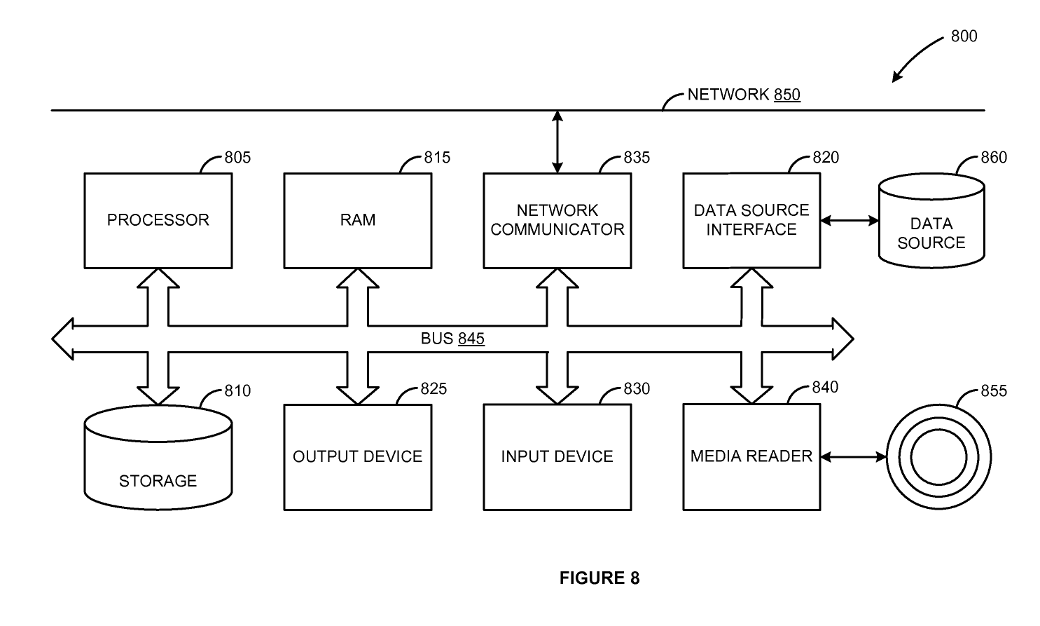

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computerized method for providing localization adaptation data, the method comprising:
providing an adapter interface for one or more adapters such that the one or more adapters implement the adapter interface with a plurality of sources having a plurality of data formats, wherein the plurality of sources include localization adaptation content;
creating one or more localization bundles for one or more consuming components;
associating each of the one or more localization bundles with at least one adapter of the one or more adapters; and
registering the one or more localization bundles with a localization service, wherein the localization service is consumed for obtaining portions of the localization adaptation content required for the one or more consuming components.

2. The method of claim 1, wherein each of the one or more adapters corresponds to each data format of the plurality of data formats.

3. The method of claim 1, wherein the localization adaptation content comprises translated texts.

4. The method of claim 1, wherein the data formats comprise one or more of: XLIFF format, ABAP format, text format, tabular format, spreadsheet format, and legacy database formats.

5. The method of claim 1, further comprising: assigning a unique identifier for each of the one or more localization bundles.

6. The method of claim 1, wherein the one or more consuming components generate user interface components.

7. The method of claim 1, wherein creating the one or more localization bundles for the one or more consuming components, comprises:
creating at least one localization bundle for each of the one or more consuming components requiring the localization adaptation content.

8. The method of claim 1, wherein associating each of the one or more localization bundles with the at least one adapter of the one or more adapters, comprises:
associating a plurality of the localization bundles with an adapter of the one or more adapters.

9. A computer system for providing localization adaptation data, comprising:
a computer memory to store program code; and
a processor to execute the program code to:
provide an adapter interface for one or more adapters such that the one or more adapters implement the adapter interface with a plurality of sources having a plurality of data formats, wherein the plurality of sources include localization adaptation content;
create one or more localization bundles for one or more consuming components;
associate each of the one or more localization bundles with at least one adapter of the one or more adapters; and
register the one or more localization bundles with a localization service, wherein the localization service is consumed for obtaining portions of the localization adaptation content required for the one or more consuming components.

10. The system of claim 9, wherein each of the one or more adapters corresponds to each data format of the plurality of data formats.

11. The system of claim 9, wherein the localization adaptation content comprises translated texts.

12. The system of claim 9, wherein the data formats comprise one or more of: XLIFF format, ABAP format, text format, spreadsheet format, and legacy database formats.

13. The system of claim 9, wherein the processor further executes the program code to: assign a unique identifier for each of the one or more localization bundles and each of the one or more consuming components.

14. The system of claim 9, wherein the one or more consuming components generate user interface components.

15. The system of claim 9, wherein the program code to create the one or more localization bundles for the one or more consuming components, comprises program code to:
create at least one localization bundle for each of the one or more consuming components requiring the localization adaptation content.

16. The system of claim 9, wherein the program code to associate each of the one or more localization bundles with the at least one adapter of the one or more adapters, comprises program code to:
associate a plurality of the localization bundles with an adapter of the one or more adapters.

17. An article of manufacture including a computer readable storage medium to tangibly store instructions, which when executed by a computer, cause the computer to:
initiate a localization service for one or more consuming components that require localization adaptation content, wherein one or more localization bundles are created for the one or more consuming components and are registered with the localization service;
select one or more adapters that are associated with the one or more localization bundles, wherein the one or more adapters implement a common adapter interface with a plurality of sources having a plurality of different data formats, wherein the plurality of sources include the localization adaptation content;
access and load portions of the localization adaptation content required for the one or more consuming components into the one or more localization bundles from one or more of the plurality of sources through the selected one or more adapters; and
use required portions of the localization adaptation content for the one or more consuming components.

18. The article of manufacture of claim 17, wherein the localization adaptation content comprises translated texts.

19. The article of manufacture of claim 17, wherein the data formats comprise one or more of: XLIFF format, ABAP format, text format, spreadsheet format, and legacy database formats.

20. The article of manufacture of claim 17, wherein instructions to use the required portions of the localization adaptation content for the one or more consuming components, comprise instructions to: generate user interface components.
